(19) United States
(12) Patent Application Publication
(10) Pub. No.: US 2023/0223572 A1
(43) Pub. Date: Jul. 13, 2023

(54) POWER SOURCE FOR AN AIRCRAFT

(71) Applicant: General Electric Company, Schenectady, NY (US)

(72) Inventors: Honggang Wang, Clifton Park, NY (US); Di Pan, Schenectady, NY (US); Kum Kang Huh, Niskayuna, NY (US)

(21) Appl. No.: 17/571,661

(22) Filed: Jan. 10, 2022

(51) Int. Cl. H01M 8/04858; H01M 8/249; B64D 41/00; B64D 27/10; B64D 27/24

(52) U.S. Cl. CPC H01M 8/0494; H01M 8/249; B64D 41/00; B64D 27/10; B64D 27/24; H01M 2250/20; B64D 2041/005; B64D 2027/026

(57) ABSTRACT

A power source for an aircraft having an engine, the power source including: a fuel cell assembly configured to be integrated into the engine, the fuel cell assembly including: a first fuel cell group; and a second fuel cell group, wherein during a first operating condition of the power source the fuel cell assembly is configured to provide a first power output from the first fuel cell group and the second fuel cell group and during a second operating condition is further configured to provide a second power output from the first fuel cell group, the second power output being different than the first power output.

### FIELD

The present disclosure relates to a power source for an aircraft and a method for providing power to an aircraft including a gas turbine engine, the power source including a fuel cell.

### BACKGROUND

The electrical power on a jet aircraft is usually provided from the generator(s) on the gas turbine engines and batteries, and in certain cases, the Auxiliary Power Unit (APU) or during a power interruption, when all other power sources have failed, a Ram Air Turbine (RAT). A mix of pneumatic, hydraulic, and electrical power is provided through generator(s), a hydraulic pump and compressor in the gas turbine engines or APU system.

In conventional aircraft, electric, hydraulic, and pneumatic power outputs are all dependent on the efficiency and capabilities of the jet turbine engines and APU system. Other forms of harnessing electrical, hydraulic, and pneumatic energy could improve the efficiency of the overall system in an aircraft.

A proton exchange membrane fuel cell (PEMFC) and a solid oxide fuel cell (SOFC) provide direct current (DC) electrical power from a chemical process. SOFC-GT is a SOFC/gas turbine engine hybrid where the unreacted byproducts from the SOFC such as oxygen and hydrogen can be utilized to condition the air used by the SOFC and increase the efficiency of the entire system to which it is electrically coupled.

Great portions of an aircraft's systems have been electrified resulting in an increase on the proportion of electrically driven loads replacing the traditional pneumatic or hydraulic loads. Traditionally, the engine driven electric machine has been the primary power source in the aircraft. Modern aircraft with increased aircraft electric loads within both the engine nacelle and the fuselage, require more distributed power sources to provide higher efficiency, reliability, and operational flexibility.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 is a cross-sectional view of a gas turbine engine in accordance with an exemplary aspect of the present disclosure.

FIG. 2 is a perspective view of an integrated fuel cell and combustor assembly in accordance with the present disclosure.

FIG. 3 is a schematic, axial view of the exemplary integrated fuel cell and combustor assembly of FIG. 2.

FIG. 4 is a schematic view of a fuel cell of a fuel cell assembly in accordance with an exemplary aspect of the present disclosure as may be incorporated into the exemplary integrated fuel cell and combustor assembly of FIG. 2.

FIG. 5 is a schematic diagram of a gas turbine engine including an integrated fuel cell and combustor assembly in accordance with an exemplary aspect of the present disclosure.

FIG. 6 is a schematic view of a vehicle and propulsion system in accordance with an exemplary aspect of the present disclosure.

FIG. 7 is a schematic diagram of a power source in accordance with an exemplary aspect of the present disclosure.

FIG. 8 is a schematic diagram of a power source in accordance with another exemplary aspect of the present disclosure.

FIG. 9 is a schematic diagram of a power source in accordance with another exemplary aspect of the present disclosure.

### DETAILED DESCRIPTION

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

For purposes of the description hereinafter, the terms “upper”, “lower”, “right”, “left”, “vertical”, “horizontal”, “top”, “bottom”, “lateral”, “longitudinal”, and derivatives thereof shall relate to the embodiments as they are oriented in the drawing figures. However, it is to be understood that the embodiments may assume various alternative variations, except where expressly specified to the contrary. It is also to be understood that the specific devices illustrated in the attached drawings, and described in the following specification, are simply exemplary embodiments of the disclosure. Hence, specific dimensions and other physical characteristics related to the embodiments disclosed herein are not to be considered as limiting.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” or “at least one of A, B, or C” refers to only A, only B, only C, or any combination of A, B, and C.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 1, 2, 4, 10, 15, or 20 percent margin. These approximating margins may apply to a single value, either or both endpoints defining numerical ranges, and/or the margin for ranges between endpoints.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

A “third stream” as used herein means a non-primary air stream capable of increasing fluid energy to produce a minority of total propulsion system thrust. A pressure ratio of the third stream may be higher than that of the primary propulsion stream (e.g., a bypass or propeller driven propulsion stream). The thrust may be produced through a dedicated nozzle or through mixing of an airflow through the third stream with a primary propulsion stream or a core air stream, e.g., into a common nozzle.

In certain exemplary embodiments an operating temperature of the airflow through the third stream may be less than a maximum compressor discharge temperature for the engine, and more specifically may be less than 350 degrees Fahrenheit (such as less than 300 degrees Fahrenheit, such as less than 250 degrees Fahrenheit, such as less than 200 degrees Fahrenheit, and at least as great as an ambient temperature). In certain exemplary embodiments these operating temperatures may facilitate heat transfer to or from the airflow through the third stream and a separate fluid stream. Further, in certain exemplary embodiments, the airflow through the third stream may contribute less than 50% of the total engine thrust (and at least, e.g., 2% of the total engine thrust) at a takeoff condition, or more particularly while operating at a rated takeoff power at sea level, static flight speed, 86 degrees Fahrenheit ambient temperature operating conditions.

Furthermore in certain exemplary embodiments, aspects of the airflow through the third stream (e.g., airstream, mixing, or exhaust properties), and thereby the aforementioned exemplary percent contribution to total thrust, may passively adjust during engine operation or be modified purposefully through use of engine control features (such as fuel flow, electric machine power, variable stators, variable inlet guide vanes, valves, variable exhaust geometry, or fluidic features) to adjust or optimize overall system performance across a broad range of potential operating conditions.

The term “turbomachine” or “turbomachinery” refers to a machine including one or more compressors, a heat generating section (e.g., a combustion section), and one or more turbines that together generate a torque output.

The term “gas turbine engine” refers to an engine having a turbomachine as all or a portion of its power source. Example gas turbine engines include turbofan engines, turboprop engines, turbojet engines, turboshaft engines, etc., as well as hybrid-electric versions of one or more of these engines.

The terms “low” and “high”, or their respective comparative degrees (e.g., -er, where applicable), when used with a compressor, a turbine, a shaft, or spool components, etc. each refer to relative speeds within an engine unless otherwise specified. For example, a “low turbine” or “low speed turbine” defines a component configured to operate at a rotational speed, such as a maximum allowable rotational speed, lower than a “high turbine” or “high speed turbine” at the engine.

A power source for an aircraft having an engine, such as a gas turbine engine is provided. The power source includes a fuel cell assembly configured to be integrated into the engine. The fuel cell assembly includes a first fuel cell group and a second fuel cell group. During a first operating condition of the power source the fuel cell assembly is configured to provide a first power output from the first fuel cell group and the second fuel cell group. During a second operating condition the fuel cell assembly is further configured to provide a second power output from the first fuel cell group, the second power output being different than the first power output. In such a manner, the first and second fuel cell groups may provide power to different power sinks needing different amount and/or types of electrical power. For example, such a fuel cell assembly may allow for electrical power to be provided to the gas turbine engine at a power output designed for accessory systems of the gas turbine engine, and for electrical power to be provided to the aircraft at a power output designed for accessory systems of the aircraft. Such may result in a more efficient system, necessitating less hardware for power conversions, etc.

In an exemplary aspect of the present disclosure, a power source for an aircraft having an engine, such as a gas turbine engine is provided. The power source includes a fuel cell assembly configured to be integrated into the engine. The fuel cell assembly includes a first fuel cell group and a second fuel cell group. During at least a first operating condition, the fuel cell assembly is configured to provide a first power output from the first fuel cell group and the second fuel cell group to a first electrical load.

In yet another exemplary aspect of the present disclosure, a method of operating a power source for an aircraft having an engine, such as a gas turbine engine is provided. The power source includes a fuel cell assembly integrated into the engine. The method including providing, during a first operating condition, a first power output to a first electrical load. The first power output being a combination of a first fuel cell group output of a first fuel cell group of the fuel cell assembly and a second fuel cell group output of a second fuel cell group of the fuel cell assembly. Providing, during a second operating condition, a first power output to the first electrical load, the first power output being the first fuel cell group output from the first fuel cell group and a second power output to a second electrical load, the second power output being the second fuel cell group output from the second fuel cell group.

In another exemplary aspect of the present disclosure, a power source for an aircraft propulsion system with an engine, such as a gas turbine engine is provided. The power source includes a first power bus; a second power bus; and a fuel cell assembly configured to be integrated into the engine. The fuel cell assembly includes a first fuel cell group and a second fuel cell group. During at least a first operating condition of the power source, the fuel cell assembly is configured to provide a first power bus output from the first fuel cell group, the second fuel cell group, or both to the first power bus and is further configured to provide a second power bus output to the second power bus, the second power bus output being different than the first power bus output.

In yet another exemplary aspect of the present disclosure, a power source for an aircraft propulsion system with a gas turbine engine including a fuel cell is provided. The power source includes a first power bus; a second power bus; and a fuel cell assembly configured to be integrated into the engine. The fuel cell assembly includes a first fuel cell group electrically coupled to the first power bus and configured to provide a first power output, and a second fuel cell group configured to provide a second power output. The second fuel cell group is selectively in electrical communication with the second power bus and configured such that when the second fuel cell group is electrically disconnected from the second power bus, the second fuel cell group provides the second power output to the first power bus. In such a manner, e.g., during a first operating condition of the power source, the first fuel cell group may be configured to provide the first power output to the first power bus and the second fuel cell group may be configured to provide the second power output to the second power bus. Further, during a second operating condition of the power source, the second fuel cell group may be configured to provide the second power output to the first power bus in combination with the first power output. Such may allow for the fuel cell assembly to provide an increase amount of power to the first power bus during an operating condition requiring a higher amount of electrical power than may otherwise be provided by the first fuel cell group alone.

For example, the power source for an aircraft of the present disclosure may provide an additional power source for the aircraft to produce electrical power and provide increased flexibility in choice of power source for operation of the aircraft. The power source of the present disclosure may augment previously employed power sources. Moreover, the power source of the present disclosure may itself be configured to provide power output redundancy. As described below in more detail, the inventive power source may include a plurality of discrete fuel cell groups and each of which providing a power output that may be selectively coupled to more than one power bus, as required by aircraft and gas turbine engine operation. Thus, numerous aircraft systems may rely on more than one of the fuel cell groups based on need or on the failure of one of the fuel cell groups. In essence, the fuel cell groups may be configured as backups for each other and for other aircraft power sources.

In addition, the power source of the present disclosure may be configured to match the power output to the required load. Thus, the power source of the present disclosure may provide a DC power output with the required voltage for the load, potentially eliminating the need for a power converter. This results in an increase efficiency in terms of wiring and weight.

As will be discussed in more detail below, fuel cells are electro-chemical devices which can convert chemical energy from a fuel into electrical energy through an electro-chemical reaction of the fuel, such as hydrogen, with an oxidizer, such as oxygen contained in the atmospheric air. Fuel cell systems may advantageously be utilized as an energy supply system because fuel cell systems may be considered environmentally superior and highly efficient when compared to at least certain existing systems. To improve system efficiency and fuel utilization and reduce external water usage, the fuel cell system may include an anode recirculation loop. As a single fuel cell can only generate about 1V voltage, a plurality of fuel cells may be stacked together (which may be referred to as a fuel cell stack) to generate a desired voltage. Fuel cells may include Solid Oxide Fuel Cells (SOFC), Molten Carbonate Fuel Cells (MCFC), Phosphoric Acid Fuel Cells (PAFC), and Proton Exchange Membrane Fuel Cells (PEMFC), all generally named after their respective electrolytes.

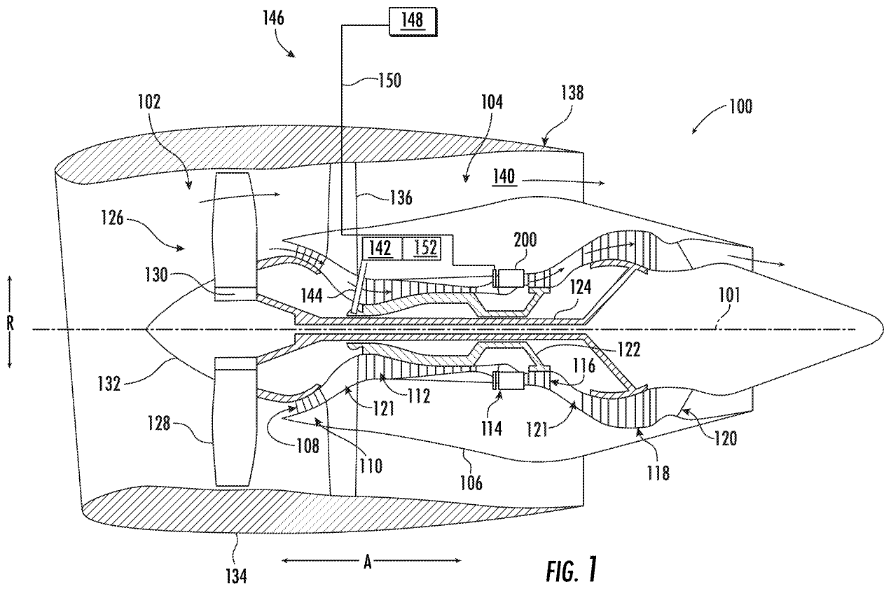

Referring now to the drawings, wherein identical numerals indicate the same elements throughout the figures, FIG. 1 provides a schematic, cross-sectional view of an engine in accordance with an exemplary embodiment of the present disclosure. The engine may be incorporated into a vehicle. For example, the engine may be an aeronautical engine incorporated into an aircraft. Alternatively, however, the engine may be any other suitable type of engine for any other suitable vehicle.

For the embodiment depicted, the engine is configured as a high bypass turbofan engine 100. As shown in FIG. 1, the turbofan engine 100 defines an axial direction A (extending parallel to a centerline axis 101 provided for reference), a radial direction R, and a circumferential direction (extending about the axial direction A; not depicted in FIG. 1). In general, the turbofan engine 100 includes a fan section 102 and a turbomachine 104 disposed downstream from the fan section 102.

The exemplary turbomachine 104 depicted generally includes a substantially tubular outer casing 106 that defines an annular inlet 108. The outer casing 106 encases, in serial flow relationship, a compressor section including a booster or low pressure (LP) compressor 110 and a high pressure (HP) compressor 112; a combustion section 114; a turbine section including a high pressure (HP) turbine 116 and a low pressure (LP) turbine 118; and a jet exhaust nozzle section 120. The compressor section, combustion section 114, and turbine section together define at least in part a core air flowpath 121 extending from the annular inlet 108 to the jet nozzle exhaust section 120. The turbofan engine further includes one or more drive shafts. More specifically, the turbofan engine includes a high pressure (HP) shaft or spool 122 drivingly connecting the HP turbine 116 to the HP compressor 112, and a low pressure (LP) shaft or spool 124 drivingly connecting the LP turbine 118 to the LP compressor 110.

For the embodiment depicted, the fan section 102 includes a fan 126 having a plurality of fan blades 128 coupled to a disk 130 in a spaced apart manner. The plurality of fan blades 128 and disk 130 are together rotatable about the centerline axis 101 by the LP shaft 124. The disk 130 is covered by a rotatable front hub 132 aerodynamically contoured to promote an airflow through the plurality of fan blades 128. Further, an annular fan casing or outer nacelle 134 is provided, circumferentially surrounding the fan 126 and/or at least a portion of the turbomachine 104. The nacelle 134 is supported relative to the turbomachine 104 by a plurality of circumferentially-spaced outlet guide vanes 136. A downstream section 138 of the nacelle 134 extends over an outer portion of the turbomachine 104 so as to define a bypass airflow passage 140 therebetween.

In such a manner, it will be appreciated that turbofan engine 100 generally includes a first stream (e.g., core air flowpath 121) and a second stream (e.g., bypass airflow passage 140) extending parallel to the first stream. In certain exemplary embodiments, the turbofan engine 100 may further define a third stream extending, e.g., from the LP compressor 110 to the bypass airflow passage 140 or to ambient. With such a configuration, the LP compressor 110 may generally include a first compressor stage configured as a ducted mid-fan and downstream compressor stages. An inlet to the third stream may be positioned between the first compressor stage and the downstream compressor stages.

Referring still to FIG. 1, the turbofan engine 100 additionally includes an accessory gearbox 142 and a fuel delivery system 146. For the embodiment shown, the accessory gearbox 142 is located within the cowling/outer casing 106 of the turbomachine 104. Additionally, it will be appreciated that for the embodiment depicted schematically in FIG. 1, the accessory gearbox 142 is mechanically coupled to, and rotatable with, one or more shafts or spools of the turbomachine 104. For example, in the exemplary embodiment depicted, the accessory gearbox 142 is mechanically coupled to, and rotatable with, the HP shaft 122 through a suitable geartrain 144. The accessory gearbox 142 may provide power to one or more suitable accessory systems of the turbofan engine 100 during at least certain operations and may further provide power back to the turbofan engine 100 during other operations. For example, the accessory gearbox 142 is, for the embodiment depicted, coupled to a starter motor/generator 152. The starter motor/generator may be configured to extract power from the accessory gearbox 142 and turbofan engine 100 during certain operation to generate electrical power and may provide power back to the accessory gearbox 142 and turbofan engine 100 (e.g., to the HP shaft 122) during other operations to add mechanical work back to the turbofan engine 100 (e.g., for starting the turbofan engine 100).

Moreover, the fuel delivery system 146 generally includes a fuel source 148, such as a fuel tank, and one or more fuel delivery lines 150. The one or more fuel delivery lines 150 provide a fuel flow through the fuel delivery system 146 to the combustion section 114 of the turbomachine 104 of the turbofan engine 100. As will be discussed in more detail below, the combustion section 114 includes an integrated fuel cell and combustor assembly 200. The one or more fuel delivery lines 150, for the embodiment depicted, provide a flow of fuel to the integrated fuel cell and combustor assembly 200.

It will be appreciated, however, that the exemplary turbofan engine 100 depicted in FIG. 1 is provided by way of example only. In other exemplary embodiments, any other suitable gas turbine engine may be utilized with aspects of the present disclosure. For example, in other embodiments, the turbofan engine may be any other suitable gas turbine engine, such as a turboshaft engine, turboprop engine, turbojet engine, etc. In such a manner, it will further be appreciated that in other embodiments the gas turbine engine may have any other suitable configuration, such as any other suitable number or arrangement of shafts, compressors, turbines, fans, etc. Further, although the exemplary gas turbine engine depicted in FIG. 1 is shown schematically as a direct drive, fixed-pitch turbofan engine, in other embodiments, a gas turbine engine of the present disclosure may be a geared gas turbine engine (i.e., including a gearbox between the fan 126 and a shaft driving the fan, such as the LP shaft 124), may be a variable pitch gas turbine engine (i.e., including a fan 126 having a plurality of fan blades 128 rotatable about their respective pitch axes), etc. Moreover, although the exemplary turbofan engine 100 includes a ducted fan 126, in other exemplary aspects, the turbofan engine 100 may include an unducted fan 126 (or open rotor fan), without the nacelle 134. Further, although not depicted herein, in other embodiments the gas turbine engine may be any other suitable type of gas turbine engine, such as a nautical gas turbine engine.

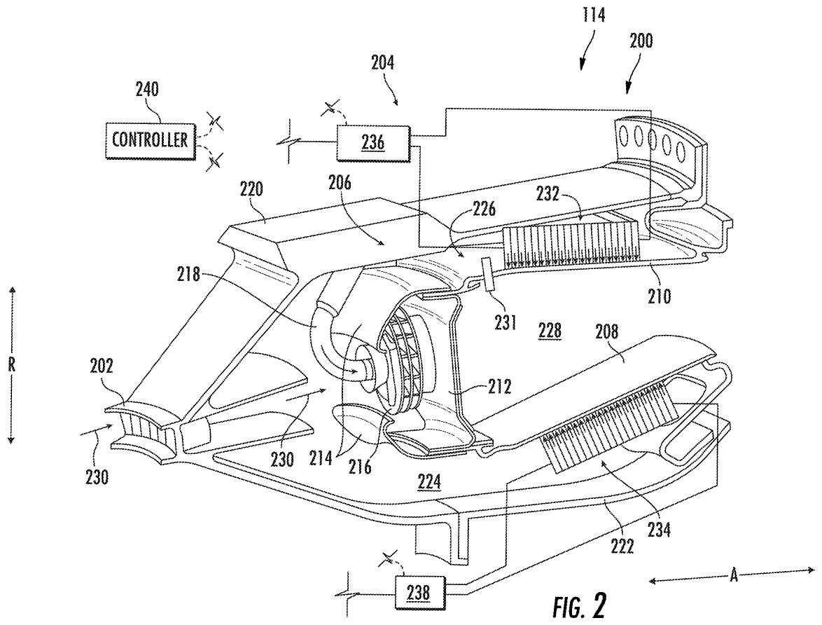

Referring now to FIG. 2, FIG. 2 illustrates schematically a portion of the combustion section 114 including a portion of the integrated fuel cell and combustor assembly 200 used in the gas turbine engine 100 of FIG. 1 (described as a turbofan engine 100 above with respect to FIG. 1), according to an embodiment of the present disclosure.

As will be appreciated, the combustion section 114 includes a compressor diffuser nozzle 202 and extends between an upstream end and a downstream end generally along the axial direction A. The combustion section 114 is fluidly coupled to the compressor section at the upstream end via the compressor diffuser nozzle 202 and to the turbine section at the downstream end.

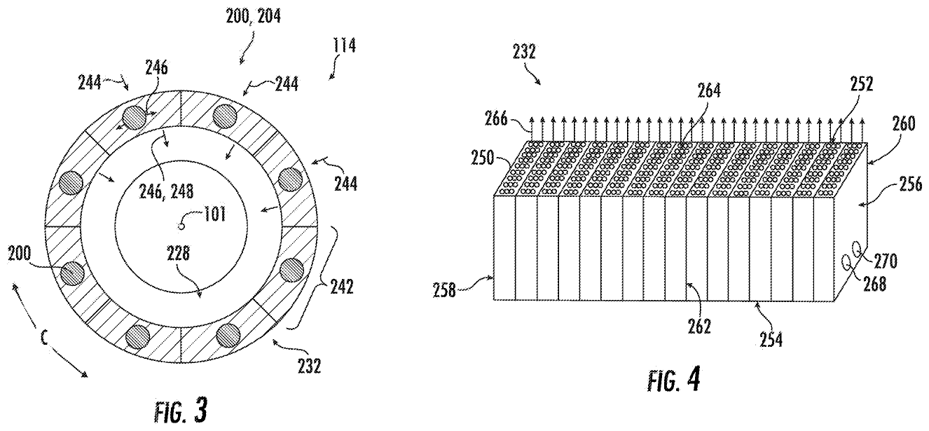

The integrated fuel cell and combustor assembly 200 generally includes a fuel cell assembly 204 (only partially depicted in FIG. 2; see also FIGS. 3 through 5) and a combustor 206. The combustor 206 includes an inner liner 208, an outer liner 210, a dome assembly 212, a cowl assembly 214, a swirler assembly 216, and a fuel flowline 218. The combustion section 114 generally includes an outer casing 220 outward of the combustor 206 along the radial direction R to enclose the combustor 206 and an inner casing 222 inward of the combustor 206 along the radial direction R. The inner casing 222 and inner liner 208 define an inner passageway 224 therebetween, and the outer casing 220 and outer liner 210 define an outer passageway 226 therebetween. The inner casing 222, the outer casing 220, and the dome assembly 212 together define at least in part a combustion chamber 228 of the combustor 206.

The dome assembly 212 is disposed proximate the upstream end of the combustion section 114 (i.e., closer to the upstream end than the downstream end) and includes an opening (not labeled) for receiving and holding the swirler assembly 216. The swirler assembly 216 also includes an opening for receiving and holding the fuel flowline 218. The fuel flowline 218 is further coupled to the fuel source 148 (see FIG. 1) disposed outside the outer casing 220 along the radial direction R and configured to receive the fuel from the fuel source 148. In such a manner, the fuel flowline 218 may be fluidly coupled to the one or more fuel delivery lines 150 described above with reference to FIG. 1.

The swirler assembly 216 can include a plurality of swirlers (not shown) configured to swirl the compressed fluid before injecting it into the combustion chamber 228 to generate combustion gas. The cowl assembly 214, in the embodiment depicted, is configured to hold the inner liner 208, the outer liner 210, the swirler assembly 216, and the dome assembly 212 together.

During operation, the compressor diffuser nozzle 202 is configured to direct a compressed fluid 230 from the compressor section to the combustor 206, where the compressed fluid 230 is configured to be mixed with fuel within the swirler assembly 216 and combusted within the combustion chamber 228 to generate combustion gasses. The combustion gasses are provided to the turbine section to drive one or more turbines of the turbine section (e.g., the high pressure turbine 116 and low pressure turbine 118).

During operation of the gas turbine engine 100 including the integrated fuel cell and combustor assembly 200, a flame within the combustion chamber 228 is maintained by a continuous flow of fuel and air. In order to provide for an ignition of the fuel and air, e.g., during a startup of the gas turbine engine 100, the integrated fuel cell and combustor assembly 200 further includes an ignitor 231. The ignitor 231 may provide a spark or initial flame to ignite a fuel and air mixture within the combustion chamber 228.

As mentioned above and depicted schematically in FIG. 2, the integrated fuel cell and combustor assembly 200 further includes the fuel cell assembly 204. The exemplary fuel cell assembly 204 depicted includes a first fuel cell stack 232 and a second fuel cell stack 234. More specifically, the first fuel cell stack 232 is configured with the outer liner 210 and the second fuel cell stack 234 is configured with the inner liner 208. More specifically, still, the first fuel cell stack 232 is integrated with the outer liner 210 and the second fuel cell stack 234 is integrated with the inner liner 208. Operation of the fuel cell assembly 204, and more specifically of a fuel cell stack (e.g., first fuel cell stack 232 or second fuel cell stack 234) of the fuel cell assembly 204 will be described in more detail below.

For the embodiment depicted, the fuel cell assembly 204 is configured as a solid oxide fuel cell (“SOFC”) assembly, with the first fuel cell stack 232 configured as a first SOFC fuel cell stack and the second fuel cell stack 234 configured as a second SOFC fuel cell stack (each having a plurality of SOFC's). As will be appreciated, a SOFC is generally an electrochemical conversion device that produces electricity directly from oxidizing a fuel. In generally, fuel cell assemblies, and in particular fuel cells, are characterized by an electrolyte material utilized. The SOFC's of the present disclosure may generally include a solid oxide or ceramic electrolyte. This class of fuel cells generally exhibit high combined heat and power efficiency, long-term stability, fuel flexibility, and low emissions.

Moreover, the exemplary fuel cell assembly 204 further includes a first power converter 236 and a second power converter 238. The first fuel cell stack 232 is in electrical communication with the first power converter 236 by a first plurality of power supply cables (not labeled), and the second fuel cell stack 234 is in electrical communication with the second power converter 238 by a second plurality of power supply cables (not labeled).

The first power converter 236 controls the electrical current drawn from the corresponding first fuel cell stack 232 and may convert the electrical power from a direct current (“DC”) power to either DC power at another voltage level or alternating current (“AC”) power. Similarly, the second power converter 238 controls the electrical current drawn from the second fuel cell stack 234 and may convert the electrical power from a DC power to either DC power at another voltage level or AC power. The first power converter 236, the second power converter 238, or both may be electrically coupled to an electric bus (such as the electric bus 326 described below).

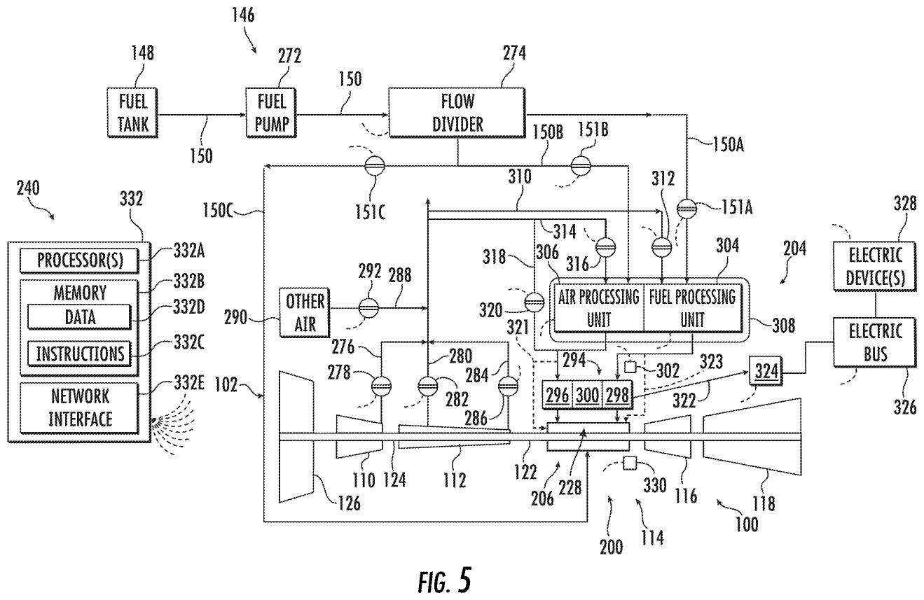

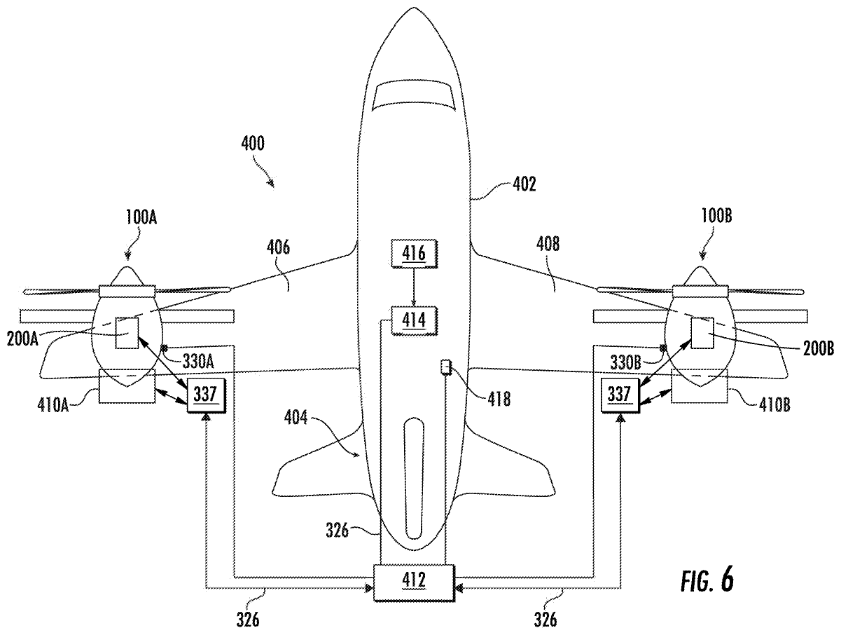

The integrated fuel cell and combustor assembly 200 further includes a fuel cell controller 240 that is in operable communication with both of the first power converter 236 and second power converter 238 to, e.g., send and receive communications and signals therebetween. For example, the fuel cell controller 240 may send current or power setpoint signals to the first power converter 236 and second power converter 238, and may receive, e.g., a voltage or current feedback signal from the first power converter 236 and second power converter 238. The fuel cell controller 240 may be configured in the same manner as the controller 240 described below with reference to FIG. 5.

It will be appreciated that in at least certain exemplary embodiments the first fuel cell stack 232, the second fuel cell stack 234, or both may extend substantially 360 degrees in a circumferential direction C of the gas turbine engine (i.e., a direction extending about the centerline axis 101 of the gas turbine engine 100). For example, referring now to FIG. 3, a simplified cross-sectional view of the integrated fuel cell and combustor assembly 200 is depicted according to an exemplary embodiment of the present disclosure. Although only the first fuel cell stack 232 is depicted in FIG. 3 for simplicity, the second fuel cell stack 234 may be configured in a similar manner.

As shown, the first fuel cell stack 232 extends around the combustion chamber 228 in the circumferential direction C, completely encircling the combustion chamber 228 around the centerline axis 101 in the embodiment shown. More specifically, the first fuel cell stack 232 includes a plurality of fuel cells 242 arranged along the circumferential direction C. The fuel cells 242 that are visible in FIG. 3 can be a single ring of fuel cells 242, with fuel cells 242 stacked together along the axial direction A (see FIG. 2) to form the first fuel cell stack 232. In another instance, multiple additional rings of fuel cells 242 can be placed on top of each other to form the first fuel cell stack 232 that is elongated along the centerline axis 101.

As will be explained in more detail, below, with reference to FIG. 5, the fuel cells 242 in the first fuel cell stack 232 are positioned to receive discharged air 244 from, e.g., the compressor section and fuel 246 from the fuel delivery system 146. The fuel cells 242 generate electrical current using this air 244 and at least some of this fuel 246, and radially direct partially oxidized fuel 246 and unused portion of air 248 into the combustion chamber 228 toward the centerline axis 101. The integrated fuel cell and combustor assembly 200 combusts the partially oxidized fuel 246 and air 248 in the combustion chamber 228 into combustion gasses that are directed downstream into the turbine section to drive or assist with driving the one or more turbines therein.

Moreover, referring now to FIG. 4, a schematic illustration is provided as a perspective view of the first fuel cell stack 232 of the integrated fuel cell and combustor assembly 200 of FIG. 2. The second fuel cell stack 234 may be formed in a similar manner.

The first fuel cell stack 232 depicted includes a housing 250 having a combustion outlet side 252 and a side 254 that is opposite to the combustion outlet side 252, a fuel and air inlet side 256 and a side 258 that is opposite to the fuel and air inlet side 256, and sides 260, 262. The side 260, the side 258, and the side 254 are not visible in the perspective view of FIG. 4.

As will be appreciated, the first fuel cell stack 232 may include a plurality of fuel cells that are “stacked,” e.g., side-by-side from one end of the first fuel cell stack 232 (e.g., fuel and air inlet side 256) to another end of the first fuel cell stack 232 (e.g., side 258). As such, it will further be appreciated that the combustion outlet side 252 includes a plurality of combustion outlets 264, each from a fuel cell of the first fuel cell stack 232. During operation, combustion gas 266 (also referred to herein as “output products”) is directed from the combustion outlets 264 out of the housing 250. As described herein, the combustion gas 266 is generated using fuel and air that is not consumed by the fuel cells inside the housing 250 of the first fuel cell stack 232.

The combustion gas 266 is provided to the combustion chamber 228 and burned during operation to generate combustion gasses used to generate thrust for the gas turbine engine 100 (and vehicle/aircraft incorporating the gas turbine engine 100).

The fuel and air inlet side 256 includes one or more fuel inlets 268 and one or more air inlets 270. Optionally, one or more of the inlets 268, 270 can be on another side of the housing 250. Each of the one or more fuel inlets 268 is fluidly coupled with a source of fuel for the first fuel cell stack 232, such as one or more pressurized containers of a hydrogen-containing gas or a fuel processing unit as described further below. Each of the one or more air inlets 270 is fluidly coupled with a source of air for the fuel cells, such as air that is discharged from a compressor section and/or an air processing unit as is also described further below. The one or more inlets 268, 270 separately receive the fuel and air from the external sources of fuel and air, and separately direct the fuel and air into the fuel cells.

In certain exemplary embodiments, the first fuel cell stack 232 of FIGS. 2 through 4 may be configured in a similar manner to one or more of the exemplary fuel cell systems (labeled 100) described in, e.g., U.S. Patent Application Publication No. 2020/0194799 A1, filed Dec. 17, 2018, that is incorporated by reference herein in its entirety. It will further be appreciated that the second fuel cell stack 234 of FIG. 2 may be configured in a similar manner as the first fuel cell stack 232, or alternatively may be configured in any other suitable manner.

It will be appreciated that, fuel cell assembly 204 of the present disclosure is divided into a plurality of fuel cell groups, with each fuel cell group capable of producing a discrete power output. As used herein, the term “group” as it relates to a fuel cell group of a fuel cell assembly refers to a plurality of fuel cells joined in a manner that may allow for electrical power to be outputted by the plurality of fuel cells separately from any other fuel cells of the fuel cell assembly during at least certain operations. For example, in the embodiment of FIG. 2, the first fuel cell stack 232 may be a first fuel cell group and the second fuel cell stack 234 may be a second fuel cell group. Alternatively, however, the fuel cell assembly 204 may include a plurality of fuel cell groups arranged along a length of the outer liner 210 along the axial direction A, a plurality of fuel cell groups arranged circumferentially along the outer liner 210 along the circumferential direction C, or a combination thereof. Separate power cables may be provided for each fuel cell group.

Further, it will be appreciated that although the exemplary fuel cell assembly 204 of FIGS. 2 through 4 generally includes the fuel cells, e.g., the fuel cells of the first fuel cell stack 232 and the second fuel cell stack 234, arranged along and integrated with the outer and inner liners 210, 208 of the combustor 206, in other embodiments, the fuel cell assembly 204 may be configured in any other suitable manner, in any other suitable location (e.g., axially forward of the combustor 206, spaced outward of the combustor 206 along the radial direction R, etc.). Further, in other embodiments, the fuel cell assembly 204 may use a chemistry other than solid oxide chemistry.

Referring now to FIG. 5, operation of an integrated fuel cell and combustor assembly 200 in accordance with an exemplary embodiment of the present disclosure will be described. More specifically, FIG. 5 provides a schematic illustration of a gas turbine engine 100 and an integrated fuel cell and combustor assembly 200 according to an embodiment of the present disclosure. The gas turbine engine 100 and integrated fuel cell and combustor assembly 200 may, in certain exemplary embodiments, be configured in a similar manner as one or more of the exemplary embodiments of FIGS. 1 through 4.

Accordingly, it will be appreciated that the gas turbine engine 100 generally includes a fan section 102 having a fan 126, an LP compressor 110, an HP compressor 112, a combustion section 114, an HP turbine 116, and an LP turbine 118. The combustion section 114 generally includes the integrated fuel cell and combustor assembly 200 having a combustor 206 and a fuel cell assembly 204.

A propulsion system including the gas turbine engine 100 further includes a fuel delivery system 146. The fuel delivery system 146 generally includes a fuel source 148 and one or more fuel delivery lines 150. The fuel source 148 may include a supply of fuel (e.g., a hydrocarbon fuel, including, e.g., a carbon-neutral fuel or synthetic hydrocarbons) for the gas turbine engine 100. In addition, it will be appreciated that the fuel delivery system 146 also includes a fuel pump 272 and a flow divider 274, and the one or more fuel delivery lines 150 include a first fuel delivery line 150A, a second fuel delivery line 150B, and a third fuel delivery line 150C. The flow divider 274 divides the fuel flow from the fuel source 148 and fuel pump 272 into a first fuel flow through the first fuel delivery line 150A to the fuel cell assembly 204, a second fuel flow through the second fuel delivery line 150B also to the fuel cell assembly 204 (and in particular to an air processing unit, described below), and a third fuel flow through a third fuel delivery line 150C to the combustor 206. The flow divider 274 may include a series of valves (not shown) to facilitate such dividing of the fuel flow from the fuel source 148, or alternatively may be of a fixed geometry. Additionally, for the embodiment shown, the fuel delivery system 146 includes a first fuel valve 151A associated with the first fuel delivery line 150A (e.g., for controlling the first fuel flow), a second fuel valve 151B associated with the second fuel delivery line 150B (e.g., for controlling the second fuel flow), and a third fuel valve 151C associated with the third fuel delivery line 150C (e.g., for controlling the third fuel flow).

The gas turbine engine 100 further includes a compressor bleed system and an airflow delivery system. More specifically, the compressor bleed system includes an LP bleed air duct 276 and an associated LP bleed air valve 278, an HP bleed air duct 280 and an associated HP bleed air valve 282, an HP exit air duct 284 and an associated HP exit air valve 286.

The gas turbine engine 100 further includes an air stream supply duct 288 (in airflow communication with an airflow supply 290) and an associated air valve 292, which is also in airflow communication with the airflow delivery system for providing compressed airflow to the fuel cell assembly 204 of the integrated fuel cell and combustor assembly 200. The airflow supply may be, e.g., a second gas turbine engine configured to provide a cross-bleed air, an auxiliary power unit (APU) configured to provide a bleed air, a ram air turbine (RAT), etc. The airflow supply may be complimentary to the compressor bleed system if the compressor air source is inadequate or unavailable.

The compressor bleed system (and air stream supply duct 288) is in airflow communication with airflow delivery system for providing compressed airflow to the fuel cell assembly 204, as will be explained in more detail below.

Referring still to FIG. 5, the fuel cell assembly 204 of the integrated fuel cell and combustor assembly 200 includes a fuel cell stack 294, which may be configured in a similar manner as, e.g., the first fuel cell stack 232 described above. The fuel cell stack 294 is depicted schematically as a single fuel cell having a cathode side 296, an anode side 298, and an electrolyte 300 positioned therebetween. As will generally be appreciated, the electrolyte 300 may, during operation, conduct negative oxygen ions from the cathode side 296 to the anode side 298 to generate an electric current and electric power.

Briefly, it will be appreciated that the fuel cell assembly 204 further includes a fuel cell sensor 302 configured to sense data indicative of a fuel cell assembly operating parameter, such as a temperature of the fuel cell stack 294 (e.g., of the cathode side 296 or anode side 298 of the fuel cell), a pressure within the fuel cell stack 294 (e.g., of within the cathode side 296 or anode side 298 of the fuel cell).

The anode side 298 may support electrochemical reactions that generate electricity. A fuel may be oxidized in the anode side 298 with oxygen ions received from the cathode side 296 via diffusion through the electrolyte 300. The reactions may create heat, steam, and electricity in the form of free electrons in the anode side 298, which may be used to supply power to an energy consuming device (such as the one or more additional electric devices 328 described below). The oxygen ions may be created via an oxygen reduction of a cathode oxidant using the electrons returning from the energy consuming device into the cathode side 296.

The cathode side 296 may be coupled to a source of the cathode oxidant, such as oxygen in the atmospheric air. The cathode oxidant is defined as the oxidant that is supplied to the cathode side 296 employed by the fuel cell system in generating electrical power. The cathode side 296 may be permeable to the oxygen ions received from the cathode oxidant.

The electrolyte 300 may be in communication with the anode side 298 and the cathode side 296. The electrolyte 300 may pass the oxygen ions from the cathode side 296 to the anode side 298, and may have little or no electrical conductivity, so as to prevent passage of the free electrons from the cathode side 296 to the anode side 298.

The anode side of a solid oxide fuel cell (such as the fuel cell stack 294) may be composed of a nickel/yttria-stabilized zirconia (Ni/YSZ) cermet. Nickel in the anode side serves as a catalyst for fuel oxidation and current conductor. During normal operation of the fuel cell stack 294, the operating temperature may be greater than or equal to about 700° C., and the nickel (Ni) in the anode remains in its reduced form due to the continuous supply of primarily hydrogen fuel gas.

The fuel cell stack 294 is disposed downstream of the LP compressor 110, the HP compressor 112, or both. Further, as will be appreciated from the description above with respect to FIG. 2, the fuel cell stack 294 may be coupled to or otherwise integrated with a liner of the combustor 206 (e.g., an inner liner 208 or an outer liner 210). In such a manner, the fuel cell stack 294 may also be arranged upstream of a combustion chamber 228 of the integrated fuel cell and combustor assembly 200, and further upstream of the HP turbine 116 and LP turbine 118.

As shown in FIG. 5, the fuel cell assembly 204 also includes a fuel processing unit 304 and an air processing unit 306. The fuel processing unit 304 may be any suitable structure for generating a hydrogen rich fuel stream. For example, the fuel processing unit 304 may include a fuel reformer or a catalytic partial oxidation convertor (CPOx) for developing the hydrogen rich fuel stream for the fuel cell stack 294. The air processing unit 306 may be any suitable structure for raising the temperature of air that is provided thereto to a temperature high enough to enable fuel cell temperature control (e.g., about 600° C. to about 800° C.). For example, in the embodiment depicted, the air processing unit includes a preburner system, operating based on a fuel flow through the second fuel delivery line 150B, configured for raising the temperature of the air through combustion, e.g., during transient conditions such as startup, shutdown and abnormal situations.

In the exemplary embodiment depicted, the fuel processing unit 304 and air processing unit 306 are manifolded together within a housing 308 to provide conditioned air and fuel to the fuel cell stack 294.

It should be appreciated, however, that the fuel processing unit 304 may additionally or alternatively include any suitable type of fuel reformer, such as an autothermal reformer and steam reformer that may need an additional stream of steam inlet with higher hydrogen composition at the reformer outlet stream. Additionally, or alternatively, still, the fuel processing unit 304 may include a reformer integrated with the fuel cell stack 294. Similarly, it should be appreciated that the air processing unit 306 of FIG. 5 could alternatively be a heat exchanger or another device for raising the temperature of the air provided thereto to a temperature high enough to enable fuel cell temperature control (e.g., about 600° C. to about 800° C.).

As mentioned above, the compressor bleed system (and air stream supply duct 288) is in airflow communication with airflow delivery system for providing compressed airflow to the fuel cell assembly 204. The airflow delivery system includes an anode airflow duct 310 and an associated anode airflow valve 312 for providing an airflow to the fuel processing unit 304, a cathode airflow duct 314 and associated cathode airflow valve 316 for providing an airflow to the air processing unit 306, and a cathode bypass air duct 318 and an associated cathode bypass air valve 320 for providing an airflow directly to the fuel cell stack 294 (or rather to the cathode side 296 of the fuel cell(s)). The fuel delivery system 146 is configured to provide the first flow of fuel through the first fuel delivery line 150A to the fuel processing unit 304, and the second flow of fuel through the second fuel delivery line 150B to the air processing unit 306 (e.g., as fuel for a preburner system, if provided).

The fuel cell stack 294 outputs the power produced as a fuel cell power output 322. Further, the fuel cell stack 294 directs a cathode air discharge and an anode fuel discharge (neither labeled for clarity purposes) into the combustion chamber 228 of the combustor 206.

In operation, the air processing unit 306 is configured to heat/cool a portion of the compressed air, incoming through the cathode airflow duct 314, to generate a processed air to be directed into the fuel cell stack 294 to facilitate the functioning of the fuel cell stack 294. The air processing unit 306 receives the second flow of fuel from the second fuel delivery line 150B and may, e.g., combust such second flow of fuel to heat the air received to a desired temperature (e.g., about 600° C. to about 800° C.) to facilitate the functioning of the fuel cell stack 294. The air processed by the air processing unit 306 is directed into the fuel cell stack 294. In an embodiment of the disclosure, as is depicted, the cathode bypass air duct 318 and the air processed by the air processing unit 306 may combine into a combined air stream to be fed into a cathode 552 of the fuel cell stack 294.

Further, as shown in the embodiment of Flig. 5, the first flow of fuel through the first fuel delivery line 150A is directed to the fuel processing unit 304 for developing a hydrogen rich fuel stream (e.g., optimizing a hydrogen content of a fuel stream), to also be fed into the fuel cell stack 294. As will be appreciated, and as discussed below, the flow of air (processed air and bypass air) to the fuel cell stack 294 (e.g., the cathode side 296) and fuel from the fuel processing unit 304 to the fuel cell stack 294 (e.g., the anode side 298) may facilitate electrical power generation.

Because the inlet air for the fuel cell stack 294 may come solely from the upstream compressor section without any other separately controlled air source, it will be appreciated that the inlet air for the fuel cell stack 294 discharged from the compressor section is subject to the air temperature changes that occur at different flight stages. By way of illustrative example only, the air within a particular location in the compressor section of the gas turbine engine 100 may work at 200° C. during idle, 600° C. during take-off, 268° C. during cruise, etc. This type of temperature change to the inlet air directed to the fuel cell stack 294 may lead to significant thermal transient issues (or even thermal shock) to the ceramic materials of the fuel cell stack 294, which could range from cracking to failure.

Thus, by fluidly connecting the air processing unit 306 between the compressor section and the fuel cell stack 294, the air processing unit 306 may serve as a control device or system to maintain the air processed by the air processing unit 306 and directed into the fuel cell stack 294 within a desired operating temperature range (e.g., plus or minus 100° C., or preferably plus or minus 50° C., or plus or minus 20° C.). In operation, the temperature of the air that is provided to the fuel cell stack 294 can be controlled (relative to a temperature of the air discharged from the compressor section) by controlling the flow of fuel to the air processing unit 306. By increasing a fuel flow to the air processing unit 306, a temperature of the airflow to the fuel cell stack 294 may be increased. By decreasing the fuel flow to the air processing unit 306, a temperature of the airflow to the fuel cell stack 294 may be decreased. Optionally, no fuel can be delivered to the air processing unit 306 to prevent the air processing unit 306 from increasing and/or decreasing the temperature of the air that is discharged from the compressor section and directed into the air processing unit 306.

Moreover, as is depicted in phantom, the fuel cell assembly 204 further includes an airflow bypass duct 321 extending around the fuel cell 294 to allow a portion or all of an airflow conditioned by the air processing unit 306 (and combined with any bypass air through duct 318) to bypass the cathode side 296 of the fuel cell 294 and go directly to the combustion chamber 228. The airflow bypass duct 321 may be in thermal communication with the fuel cell 294. The fuel cell assembly further includes a fuel bypass duct 323 extending around the fuel cell 294 to allow a portion or all of a reformed fuel from the fuel processing unit 304 to bypass the anode side 298 of the fuel cell 294 and go directly to the combustion chamber 228.

As briefly mentioned above, the fuel cell stack 294 converts the anode fuel stream from the fuel processing unit 304 and air processed by the air processing unit 306 sent into the fuel cell stack 294 into electrical energy, the fuel cell power output 322, in the form of DC current. This fuel cell power output 322 is directed to a power convertor 324 in order to change the DC current into DC current or AC current that can be effectively utilized by one or more subsystems. In particular, for the embodiment depicted, the electrical power is provided from the power converter to an electric bus 326. The electric bus 326 may be an electric bus dedicated to the gas turbine engine 100, an electric bus of an aircraft incorporating the gas turbine engine 100, or a combination thereof. The electric bus 326 is in electric communication with one or more additional electrical devices 328, which may be adapted to draw an electric current from, or apply an electrical load to, the fuel cell stack 294. The one or more additional electrical devices 328 may be a power source, a power sink, or both. For example, the additional electrical devices 328 may be a power storage device (such as one or more batteries), an electric machine (an electric generator, an electric motor, or both), an electric propulsion device, etc. For example, the one or more additional electric devices 328 may include the starter motor/generator of the gas turbine engine 100.

Referring still to FIG. 5, the gas turbine engine 100 further includes a sensor 330. In the embodiment shown, the sensor 330 is configured to sense data indicative of a flame within the combustion section 114 of the gas turbine engine 100. The sensor 330 may be, for example, a temperature sensor configured to sense data indicative of an exit temperature of the combustion section 114, an inlet temperature of the turbine section, an exhaust gas temperature, or a combination thereof. Additionally, or alternatively, the sensor 330 may be any other suitable sensor, or any suitable combination of sensors, configured to sense one or more gas turbine engine operating conditions or parameters, including data indicative of a flame within the combustion section 114 of the gas turbine engine 100.

Moreover, as is further depicted schematically in FIG. 5, the propulsion system, an aircraft including the propulsion system, or both, includes a controller 240. For example, the controller 240 may be a standalone controller, a gas turbine engine controller (e.g., a full authority digital engine control, or FADEC, controller), an aircraft controller, supervisory controller for a propulsion system, a combination thereof, etc.

The controller 240 is operably connected to the various sensors, valves, etc. within at least one of the gas turbine engine 100 and the fuel delivery system 146. More specifically, for the exemplary aspect depicted, the controller 240 is operably connected to the valves of the compressor bleed system (valves 278, 282, 286), the airflow delivery system (valves 312, 316, 320), and the fuel delivery system 146 (flow divider 274, valves 151A, 151B, 151C), as well as the sensor 330 of the gas turbine engine 100 and the fuel cell sensor 302. As will be appreciated from the description below, the controller 240 may be in wired or wireless communication with these components. In this manner, the controller 240 may receive data from a variety of inputs (including the gas turbine engine sensor 330 and the fuel cell sensor 302), may make control decisions, and may provide data (e.g., instructions) to a variety of outputs (including the valves of the compressor bleed system to control an airflow bleed from the compressor section, the airflow delivery system to direct the airflow bled from the compressor section, and the fuel delivery system 146 to direct the fuel flow within the gas turbine engine 100).

Referring particularly to the operation of the controller 240, in at least certain embodiments, the controller 240 can include one or more computing device(s) 332. The computing device(s) 332 can include one or more processor(s) 332A and one or more memory device(s) 332B. The one or more processor(s) 332A can include any suitable processing device, such as a microprocessor, microcontroller, integrated circuit, logic device, and/or other suitable processing device. The one or more memory device(s) 332B can include one or more computer-readable media, including, but not limited to, non-transitory computer-readable media, RAM, ROM, hard drives, flash drives, and/or other memory devices.

The one or more memory device(s) 332B can store information accessible by the one or more processor(s) 332A, including computer-readable instructions 332C that can be executed by the one or more processor(s) 332A. The instructions 332C can be any set of instructions that when executed by the one or more processor(s) 332A, cause the one or more processor(s) 332A to perform operations. In some embodiments, the instructions 332C can be executed by the one or more processor(s) 332A to cause the one or more processor(s) 332A to perform operations, such as any of the operations and functions for which the controller 240 and/or the computing device(s) 332 are configured, the operations for operating a propulsion system (e.g., method 600), as described herein, and/or any other operations or functions of the one or more computing device(s) 332. The instructions 332C can be software written in any suitable programming language or can be implemented in hardware. Additionally, and/or alternatively, the instructions 332C can be executed in logically and/or virtually separate threads on processor(s) 332A. The memory device(s) 332B can further store data 332D that can be accessed by the processor(s) 332A. For example, the data 332D can include data indicative of power flows, data indicative of gas turbine engine 100/aircraft operating conditions, and/or any other data and/or information described herein.

The computing device(s) 332 also includes a network interface 332E configured to communicate, for example, with the other components of the gas turbine engine 100 (such as the valves of the compressor bleed system (valves 278, 282, 286), the airflow delivery system (valves 312, 316, 320), and the fuel delivery system 146 (flow divider 274, valves 151A, 151B, 151C), as well as the sensor 330 of the gas turbine engine 100 and the fuel cell sensor 302), the aircraft incorporating the gas turbine engine 100, etc. The network interface 332E can include any suitable components for interfacing with one or more network(s), including for example, transmitters, receivers, ports, controllers, antennas, and/or other suitable components. In such a manner, it will be appreciated that the network interface 332E may utilize any suitable combination of wired and wireless communications network(s).

The technology discussed herein makes reference to computer-based systems and actions taken by and information sent to and from computer-based systems. It will be appreciated that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

It will be appreciated that the gas turbine engine 100, the exemplary fuel delivery system 146, the exemplary integrated fuel cell and combustor assembly 200, and the exemplary fuel cell assembly 204 are provided by way of example only. In other embodiments, the integrated fuel cell and combustor assembly 200 and fuel cell assembly 204 may have any other suitable configuration. For example, in other exemplary embodiments, the fuel cell assembly 204 may include any other suitable fuel processing unit 304. Additionally, or alternatively, the fuel cell assembly 204 may not require a fuel processing unit 304, e.g., when the combustor of the gas turbine engine 100 is configured to burn hydrogen fuel and the fuel delivery assembly 146 is configured to provide hydrogen fuel to the integrated fuel cell and combustor assembly 200, and in particular to the fuel cell assembly 204.

As briefly mentioned above, the fuel cell assembly 204 may be in electrical communication with the electric bus 326, which may be an electric bus of the gas turbine engine 100, of an aircraft, or a combination thereof. Referring now briefly to FIG. 6, a schematic view is provided of an aircraft 400 in accordance with an embodiment of the present disclosure including one or more gas turbine engines 100 (labeled 100A and 100B), each with an integrated fuel cell and combustor assembly 200 (labeled 200A and 200B), and an aircraft electric bus 326 in electrical communication with the one or more gas turbine engines 100.

In particular, for the exemplary embodiment depicted, the aircraft 400 is provided including a fuselage 402, an empennage 404, a first wing 406, a second wing 408, and a propulsion system. The propulsion system generally includes a first gas turbine engine 100A coupled to, or integrated with, the first wing 406 and a second gas turbine engine 100B coupled to, or integrated with, the second wing 408. It will be appreciated, however, that in other embodiments, any other suitable number and or configuration of gas turbine engines 100 may be provided (e.g., fuselage-mounted, empennage-mounted, etc.).

The first gas turbine engine 100A generally includes a first integrated fuel cell and combustor assembly 200A and a first electric machine 410A. The first integrated fuel cell and combustor assembly 200A may generally include a first fuel cell assembly. The first electric machine 410A may be an embedded electric machine, an offset electric machine (e.g., rotatable with the gas turbine engine 100 through an accessory gearbox or suitable geartrain), etc. For example, in certain exemplary embodiments, the first electric machine 410A may be a starter motor/generator for the first gas turbine engine 100A.

Similarly, the second gas turbine engine 100B generally includes a second integrated fuel cell and combustor assembly 200B and a second electric machine 410B. The second integrated fuel cell and combustor assembly 200B may generally include a second fuel cell assembly. The second electric machine 410B may also be an embedded electric machine, an offset electric machine (e.g., rotatable with the gas turbine engine 100 through an accessory gearbox or suitable geartrain), etc. For example, in certain exemplary embodiments, the second electric machine 410B may be a starter motor/generator for the second gas turbine engine 100B.

In the embodiment of FIG. 6, the aircraft 400 additionally includes the electric bus 326 and a supervisory controller 412. Further, it will be appreciated that the aircraft 400 and/or propulsion system includes one or more electric devices 414 and an electric energy storage unit 416, each in electric communication with the electric bus 326. The electric devices 414 may represent one or more aircraft power loads (e.g., avionics systems, control systems, electric propulsors, etc.), one or more electric power sources (e.g., an auxiliary power unit), etc. The electric energy storage unit 416 may be, e.g., a battery pack or the like for storing electric power.

The electric bus 326 further electrically connects to the first electric machine 410A and first fuel cell assembly, as well as to the second electric machine 410B and second fuel cell assembly. The supervisory controller 412 may be configured in a similar manner as the controller 240 of FIG. 5 or may be in operative communication with a first gas turbine engine controller dedicated to the first gas turbine engine 100A and a second gas turbine engine controller dedicated to the second gas turbine engine 100B.

In such a manner, it will be appreciated that the supervisory controller 412 may be configured to receive data from a gas turbine engine sensor 330A of the first gas turbine engine 100A and from a gas turbine engine sensor 330B of the second gas turbine engine 100B and may further be configured to send data (e.g., commands) to various control elements (such as valves) of the first and second gas turbine engines 100A, 100B.

Moreover, it will be appreciated that for the embodiment depicted, the aircraft 400 includes one or more aircraft sensor(s) 418 configured to sense data indicative of various flight operations of the aircraft 400, including, e.g., altitude, ambient temperature, ambient pressure, airflow speed, etc. The supervisory controller 412 is operably connected to these aircraft sensor(s) 418 to receive data from such aircraft sensor(s) 418.

In addition to receiving data from sensors 330A, 330B, 418 and sending data to control elements, the supervisory controller 412 is configured to control a flow of electric power through the electric bus 326. For example, the supervisory controller 412 may be configured to command and receive a desired power extraction from one or more of the electric machines (e.g., the first electric machine 410A and second electric machine 410B), one or more of the fuel cell assemblies (e.g., the first fuel cell assembly and second fuel cell assembly), or both, and provide all or a portion of the extracted electric power to other of the one or more of the electric machines (e.g., the first electric machine 410A and second electric machine 410B), one or more of the fuel cell assemblies (e.g., the first fuel cell assembly and second fuel cell assembly), or both. One or more of these actions may be taken in accordance with the logic outlined below.

In one embodiment, fuel cell assembly 204 of each integrated fuel cell and combustor assembly 200 (labeled 200A and 200B; see also FIGS. 2 through 5) is divided into a plurality of fuel cell groups, with each fuel cell group producing a discrete power output. For example, the first fuel cell stack 232 may be configured as a first fuel cell group with a first power output and the second fuel cell stack 234 may be configured as a second fuel cell group with a second power output. The first and second fuel cell groups may be arranged on the outer and inner liners 210, 208 of the combustor 206 (as in FIG. 2), may be arranged axially along one of the outer or inner liners 210, 208 of the combustor 206, may be arranged circumferentially along one or both of the outer or inner liners 210, 208 of the combustor 206, or may be arranged in any other suitable manner. Further, in other embodiments, the fuel cell assembly 204 may include more than two groups (e.g., 3, 4, 5, or more groups, such as up to 20 groups).

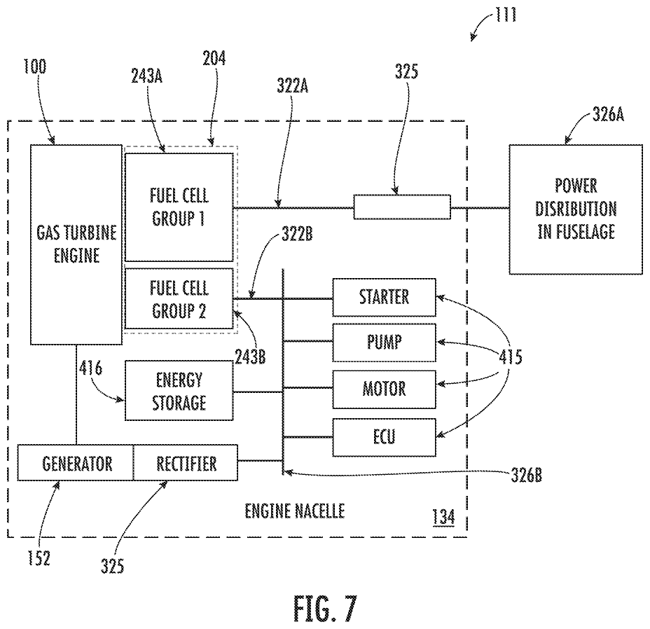

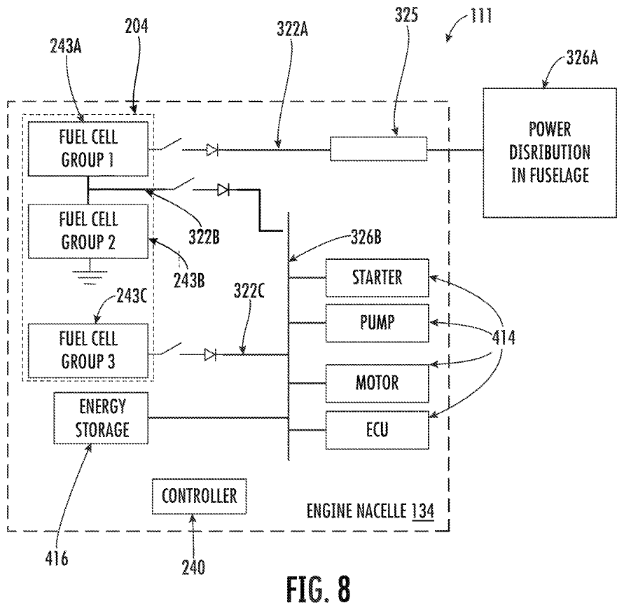

Referring now to FIGS. 7 and 8, a power source 111 is provided including a fuel cell assembly 204 associated with a gas turbine engine 100. The fuel cell assembly 204 may be configured in a similar manner as the exemplary fuel cell assembly 204 of FIGS. 2 through 5, and the gas turbine engine 100 may be configured in a similar manner as the exemplary gas turbine engine 100 of FIG. 1. For example, the gas turbine engine 100 generally includes a casing (which may be the nacelle 134 or the casing 106; see FIG. 1). In the embodiment of FIG. 7, the casing is referred to as the nacelle 134. It will be appreciated, however, that in other embodiments, the casing may instead be the casing 106 of the gas turbine engine 100.

The fuel cell assembly 204 includes a first fuel cell group 243A and a second fuel cell group 243B. The first fuel cell group 243A is electrically coupled to a first power bus 326A and configured to provide a first power output 322A. The second fuel cell group 243B is selectively electrically coupled to a second power bus 326B and configured to provide a second power output 322B.

As will be appreciated from the schematic representation in FIG. 8, the second fuel cell group 243B includes an electrical return, with the first and second fuel cell groups 243A, 243B sharing the electrical return. More specifically, for the embodiment shown, the electrical return includes an electrical grounding, such that for the embodiment shown the second fuel cell group 243B is electrically grounded through, e.g., a direct electrical connection to a grounding structure (i.e., through one or more wires, cables, or the like and not through any other electrical devices). Although not depicted, it will be appreciated that the second fuel cell group 243B may be grounded to a frame assembly of the engine. By contrast, for the embodiment shown, the first fuel cell group 243A is only electrically grounded through the second fuel cell group 243B.

It will be appreciated that the first and second fuel cell groups 243A, 243B, although shown schematically as separate sets of fuel cells, the first and second fuel cell groups 243A, 243B may be configured as a single stack of fuel cells arranged, e.g., in series electrical flow (see, e.g., FIG. 4). For example, each of the fuel cells of the first and second fuel cell groups 243A, 243B may be contained in a common housing. Further, although two fuel cell groups (i.e., the first and second fuel cell groups 243A, 243B) are shown in FIG. 8 with a power output 322B therebetween, in other embodiments, the fuel cell assembly 204 may include a fuel cell stack having any other suitable number of fuel cell groups with power output(s) therebetween to facilitate extraction of electrical power from various locations and at various voltages.

Moreover, although the shared electrical return of the first and second fuel cell groups 243A, 243B is located at an end of the second fuel cell group 243B opposite from the first fuel cell group 243A, in other embodiments, the electrical return may instead be located at some mid-point location of the first and second fuel cell groups 243A, 243B (e.g., between the first and second fuel cell groups 243A, 243B). With such a configuration a positive and a negative voltage may be extracted from the first and second fuel cell groups 243A, 243B, with one of the voltages selectively provided to, e.g., the second power bus 326B (in a similar manner as described below).

During at least a first operating condition of the power source 111 the fuel cell assembly 204 is configured to provide a first power bus output from the first fuel cell group 243A, the second fuel cell group 243B, or both to the first power bus 326A. Further, during at least the first operating condition of the power source, the fuel cell assembly 204 is configured to provide a second power bus output to the second power bus 326B, with the second power bus output being different than the first power bus output. More specifically, for the embodiment of FIG. 7, the first fuel cell group 243A is configured to provide the first power output 322A and is electrically coupled to the first power bus 326A for providing the first power output 322A to the first power bus 326A as the first power bus output, and the second fuel cell group 243B is configured to provide the second power output 322B and is electrically coupled to the second power bus 326B for providing the second power output 322B to the second power bus 326B as the second power bus output.

As with the embodiment of FIG. 7, for the embodiment of FIG. 8, the first power output 322A is different than the second power output 322B. For example, depending on the demands on the power source 111, the first power output 322A may be at a different voltage than the second power output 322B, may be at a different current than the second power output 322B, or both. For example, in at least certain exemplary embodiments, the first and second power outputs 322A, 322B may be at voltages having at least about a 10% difference (e.g., calculated by absolute value of: (voltage of first power output 322A—voltage of second power output 322B)/voltage of first power output 322A), such as at least about a 20% difference, such as at least about a 30% difference, such as at least about a 40% difference, such as at least about a 50% difference, such as at least about a 100% difference, such as up to about a 1000% difference. Additionally or alternatively, in at least certain exemplary embodiments, the first and second power outputs 322A, 322B may be at currents having at least about a 10% difference (e.g., calculated by absolute value of: (current of first power output 322A—current of second power output 322B)/current of first power output 322A), such as at least about a 20% difference, such as at least about a 30% difference, such as at least about a 40% difference, such as at least about a 50% difference, such as at least about a 100% difference, such as up to about a 1000% difference.

In at least certain exemplary embodiments, the first power output 322A may be greater than the second power output 322B. Such may enable for efficient energy transfer to and through the aircraft over a longer distance.

In at least certain exemplary embodiments, the first and second fuel cell groups 243A, 243B may be structured to provide the different power outputs. For example, the first and second fuel cell groups 243A, 243B may include a different total number of fuel cells connected in series (see FIG. 4); may have different heights, widths, or both such that an electrolyte layer of the fuel cells define a different total surface area (see layer 300 of FIG. 5); may be structured to receive a different amount of fuel, air, or both; etc.

In such a manner, it will be appreciated that the first and second fuel cell groups 243A, 243B may provide their respective power outputs 322A, 322B to unique power sinks. For example, for the embodiment depicted the first power bus distributes power to an aircraft external to the engine nacelle 134, and more particularly to an aircraft power bus (first power bus 326A) electrically coupled to one or more aircraft accessory systems external to the gas turbine engine 100 (e.g., electronic devices 414, see FIG. 6).

By contrast, for the exemplary embodiment depicted, the second power bus 326B is located internally with respect to the engine nacelle 134 and is configured in electrical communication with one or more gas turbine engine accessory systems 415 for providing all or part of the second power output 322B to the one or more gas turbine engine accessory systems. For example, in an embodiment, the second power bus 326B is electrically coupled to provide power to one or more of a starter, a hydraulic or pneumatic pump, an electric motor, an engine control unit (ECU), or combination thereof located inside the engine nacelle 134.

In the embodiments depicted, the power source 111 further includes an electric energy storage system 416. The second power bus 326B is also electrically coupled to the electric energy storage system 416, such as a battery, which can provide power to the second power bus 326B or be recharged by the second fuel cell group 243A through the second power bus 326B, as needed.

Further, in certain exemplary embodiments, the power source 111 also includes an alternative power source, and more specifically for the embodiment depicted in FIG. 7, includes a starter motor/generator 152 electrically coupled to the second power bus 326B. For the embodiment depicted, the alternative power source is electrically connected through a power converter, such as through an AC/DC power converter 325 (“Rectifier”) such that it may electrically communicate with the second power bus and provide a power output to the second power bus.

In other embodiments, the alternative power source may additionally or alternatively include an auxiliary power unit, additional fuel cell groups, a power output from another power bus, or the like. Further, in other embodiments, the second power bus 326B may operate on AC power, and therefore the power source 111 may not include the power converter 325, and instead may include and AC/AC converter to match the voltage, or may directly connect to the second power bus 326B.

In an embodiment, the fuel cell assembly 204 is a solid oxide fuel cell assembly, and the gas turbine engine 100 includes a combustion section in which fuel cells include an outlet positioned to provide output products from the fuel cell to the combustion section (see, e.g., FIGS. 2 through 5).

In certain embodiments of the present disclosure, the first power bus 326A may be an AC power bus or a DC power bus, as desired. Moreover, the first fuel cell group 243A may be electrically coupled to the first power bus 326A either directly (i.e., without a power converter) or with a DC/AC power converter or a DC/DC power converter 325, as may be required. The converter 325 may be a full power converter or a partial power converter (as described in U.S. Pat. No. 9,809,119 (which is incorporated herein by this reference)).

Likewise, in certain embodiments of the present disclosure, the second power bus 326B may be an AC power bus or a DC power bus, as desired. Thus, the second fuel cell group 243B may be electrically coupled to the second power bus 326B either directly (i.e., without a power converter) or with an DC/AC power converter or a DC/DC power converter (not shown), as required.

However, in the exemplary embodiment depicted, the first power bus 326A is an AC power bus electrically coupled to the first fuel cell group 243A with a DC/AC power converter 325 and the second power bus 326B is a DC power bus directly electrically coupled to the second fuel cell group 243B. With such a configuration, the second power output 322B has a voltage sized to match a load required by the second power bus 326B without the need for a power converter.

In embodiments, the power source 111 may include one or more controllers 240 (FIG. 8) electrically coupled to the fuel cell groups 243A, 243B, the alternative power source, the electric energy storage unit 416, or a combination thereof to control allocation of power from the fuel cell groups, the generator 152, and the energy storage system 416. The one or more controllers 240 may be configured in a similar manner to the controller 240 of FIG. 2 or 5. In such a manner, it will further be appreciated that the one or more controllers 240 may be configured to control one or more fuel cell operating conditions to, inter alia, modify the first power output 322A, the second power output 322B, or both.

Referring specifically to FIG. 8, a schematic view is provided of a power system in accordance with another exemplary embodiment of the present disclosure.

In the embodiment of FIG. 8, the power source 111 may be configured in a similar manner as the exemplary power source 111 described above with respect to FIG. 7.

For example, the power source 111 includes a first power bus 326A and a second power bus 326B. The fuel cell assembly 204 includes a first fuel cell group 243A and a second fuel cell group 243B. The first fuel cell group 243A is electrically coupled to the first power bus 326A and is configured to provide a first power output 322A. However, for the embodiment shown, the second fuel cell group 243B is selectively electrically coupled to the second power bus 326B and is configured to provide a second power output 322B.

More specifically, as with the embodiment of FIG. 7, during at least a first operating condition of the power source 111, the fuel cell assembly 204 is configured to provide a first power bus output from the first fuel cell group 243A, the second fuel cell group 243B, or both to the first power bus 326A. Further, during at least the first operating condition of the power source 111, the fuel cell assembly 204 is configured to provide a second power bus output to the second power bus 326B, with the second power bus output being different than the first power bus output. The first power output 322A of the first fuel cell group 243A is electrically coupled to the first power bus 326A for providing the first power output 322A to the first power bus 326A as part of the first power bus output. However, as mentioned, for the embodiment of FIG. 8, the second fuel cell group 243B is selectively in electrical communication with the second power bus 326B and is configured to provide the second power output 322B. When the second fuel cell group 243B is electrically disconnected from the second power bus 326B, the second fuel cell group 243B provides the second power output 322B to the first power bus 326A as part of the first power bus output.

More specifically, during at least the first operating condition, the second fuel cell group 243B is electrically disconnected from the second power bus 326B, and when the second fuel cell group 243B is electrically disconnected from the second power bus 326B, the second fuel cell group 243B is electrically connected to the first power bus 326A through the first fuel cell group 243A in series. By contrast, during a second operating condition of the power source 111, the second fuel cell group 243B is electrically connected to the second power bus 326B (and electrically disconnected from the first power bus 326A and the first fuel cell group 243A). during a third operating condition, the second fuel cell group 243B is electrically connected to the first power bus 326A through the first fuel cell group 243A in series, and the second fuel cell group 243B is also electrically connected to the second power bus 326B.

Accordingly, it will be appreciated that the fuel cell assembly 204 may be capable of providing a higher range of power outputs to the first power bus 326A (i.e., a higher range of first power bus outputs). For example, during the first operating condition of the power source 111, the power source 111 may include the first and second fuel cell group 243A, 243B arranged in series to provide a relatively high first power bus output to the first power bus 326A. For example, the first operating condition may be a high power demand condition for the aircraft accessory systems, or a high power demand condition for any other power sinks electrically coupled to the first power bus 326A. By contrast, during the second operating condition of the power source 111, the first and second fuel cell group 243A, 243B may be electrically disconnected, and separately electrically coupled to the first and second power busses 326A, 326B, respectively. The second operating condition may be a low power demand condition for the aircraft accessory systems 414 (see FIG. 6). In the alternative, the second operating condition may be a high-power demand for the engine accessory systems 415, etc. and the second fuel cell group 243B may have a larger size or higher power output than first fuel cell group 243A. During a third operating condition, the second fuel cell group 243B is electrically connected to the first power bus 326A through the first fuel cell group 243A in series and the second fuel cell group 243B is also electrically connected to the second power bus 326B.

Further, for the exemplary embodiment of FIG. 8, the power source 111 additionally includes a third fuel cell group 243C electrically coupled to the second power bus 326B, and more specifically is selectively electrically coupled to the second power bus 326B. The third fuel cell group 243C is configured to selectively provide a third power output 322C to the second power bus 326B.

As noted, in the exemplary embodiment depicted the third fuel cell group 243C is selectively in electrical communication with the second power bus 326B and configured to selectively provide the third power output 322C to the second power bus 326B. In such a manner, electric power may be provided from the third fuel cell group 243C to the second power bus 326B only as required or desired. For example, the third fuel cell group 243C may be configured to provide electric power to the second power bus 326B during a high power demand condition for the engine accessory systems (in which case both the second and third fuel cell groups 243B, 243C may be electrically coupled to the second power bus 326B), during a high power demand condition for the aircraft accessory systems (and when, e.g., the second fuel cell group 243B provides electrical power to the first power bus 326A), or both. Such may provide more options for controlling the power system of FIG. 8 and may provide redundancy to the second power bus.

As noted, for the exemplary embodiment of FIG. 8, the second fuel cell group 243B is selectively in electrical communication with one of the first fuel cell group 243A or with the second power bus 326B. In this embodiment, the first power bus 326A defines a maximum allowable voltage and a combination of the first power output 322A and the second power output 322B is less than the maximum allowable voltage. In such a manner, the first power bus 326A may accept electrical power from both the first fuel cell group 243A and the second fuel cell group 243B.

As used herein, the term “maximum allowable voltage” refers to a maximum amount of voltage the power bus may handle without prematurely degrading the power bus, damaging electrical components connected to the power bus, or both.

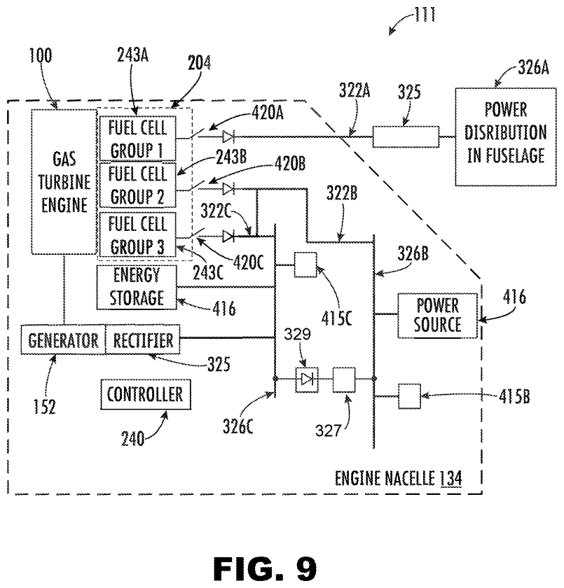

Referring now to FIG. 9, a schematic view is provided of a power system in accordance with another exemplary embodiment of the present disclosure. In the embodiment of FIG. 9, the power source 111 may be configured in a similar manner as the exemplary power source 111 described above with respect to FIG. 8.

For example, the fuel cell assembly 204 includes a first fuel cell group 243A and a second fuel cell group 243B. The first fuel cell group 243A is electrically coupled to a first power bus and is configured to provide a first power output 322A. The second fuel cell group 243B is electrically coupled to a second power bus and is configured to provide a second power output 322B. For the embodiment depicted, the second fuel cell group 243B is not selectively in electrical communication with the first fuel cell group and first power bus 326B. However, in other embodiments, the second fuel cell group 243B may be selectively in electrical communication with the first fuel cell group and first power bus 326B (see FIGS. 8 through 9).

Further, the power source 111 additionally includes a third fuel cell group 243C. However, for the embodiment depicted, the power source 111 further includes third power bus 326C, and the third fuel cell group 243C is electrically coupled to the third power bus 326C and configured to provide the third power output 322C to the third power bus 326C during at least certain operating conditions. In such an embodiment, the third power bus 326C may also be located within the casing of the engine, such as within engine nacelle 134.

Referring specifically to FIG. 9, it will be appreciated that the second fuel cell group 243B and second power bus 326B may provide redundancy to the third fuel cell group 243C and third power bus 326C, and/or vice versa.

For example, the second fuel cell group 243B is selectively electrically coupled to the second power bus 326B and configured to provide the second power output 322B. The third fuel cell group 243C is selectively electrically coupled to the third power bus 326C and configured to provide the third power output 322C. During an operating condition wherein the second cell group 243B is electrically disconnected from the second power bus 326B, the third fuel cell group 243C may provide the third power output 322C to both the second and third power busses 326B, 326C.

More specifically, for the exemplary embodiment depicted in FIG. 9, the second power bus 326B is electrically coupled to the third power bus 326C through, for the embodiment shown, one or more power electronics. In particular, for the embodiment depicted, the second power bus 326B is electrically coupled to the third power bus 326C through a fuse 327 and a blocking diode 329. The blocking diode operates to allow power flow from the third power bus 326C to the second power bus 326B and prevent power flow in the reverse direction. The fuse 327 is sized to determine the short circuit capability. For example, the second power bus 326B may define a maximum allowable voltage, and the fuse 327 may be configured to trip at a voltage lower than the maximum allowable voltage of the second power bus 326B.

During a failure mode, such as a failure of an electrical connection between the third fuel cell group 243C and the third power bus 326C, power from the second power bus may pass through the fuse 327 and blocking diode 329 to provide power to the third power bus 326C. Further, during such an operation, the electric energy storage unit 416 may add electric power to the second power bus 326B, and thus to the third power bus 326C, supplementing the second power output 322B.

It will be appreciated, however, that in other embodiments, the blocking diode 329 may instead be configured to block power flow from the second power bus 326B to the third power bus 326C and allow power flow in the reverse direction.

Referring still to the embodiment depicted in FIG. 9, in certain exemplary aspects, the third power bus 326C may generally operate at a higher voltage than the second power bus. Further, it will be appreciated that the second power bus 326B is electrically connected to one or more second engine accessory systems 415B, and that the third electric power bus 326C is electrically coupled to one or more third engine accessories 415C. The second fuel cell group 243B and third fuel cell group 243C may each be configured such that the second power output 322B and third power output 322C operate with the one or more second engine accessory systems 415B and the one or more third engine accessory systems 415C, respectively, without the need for any voltage conversions and thus without the need for any DC/DC converters or the like.

In such a manner, it may be desirable to prevent the relatively high voltage from the third power bus 326C from flowing to the second power bus during normal operation through inclusion of, e.g., the blocking diode 329.

As will further be appreciated, the power system includes a plurality of switches, and in particular includes, a first switch 420A to selectively electrically connect the first fuel cell group 243A to the first power bus 326A, a second switch 420B to selectively electrically connect the second fuel cell group 243B to the second power bus 326B, and a third switch 420C to selectively electrically connect the third fuel cell group 243C to the third power bus 326C. The controller 240 may be operably connected to one or more of these switches 420A, 420B and/or 420C to selectively electrically connect the components in response to, e.g., various sensed data, control decisions, or the like.

Further aspects are provided by the subject matter of the following clauses:

A power source for an aircraft having an engine, the power source comprising: a fuel cell assembly configured to be integrated into the engine, the fuel cell assembly comprising: a first fuel cell group; and a second fuel cell group, wherein during a first operating condition of the power source the fuel cell assembly is configured to provide a first power output from the first fuel cell group and the second fuel cell group and during a second operating condition is further configured to provide a second power output from the first fuel cell group, the second power output being different than the first power output.

The power source of one or more of these clauses, wherein the first power output provides power to a first electrical load.

The power source of one or more of these clauses, further comprising a first DC power bus, wherein the first power output provides power to a first electrical load through the first DC power bus.

The power source of one or more of these clauses, wherein the first electrical load is an engine accessory selected from a group consisting of an engine pump, an engine starter, an engine control unit, and a combination thereof.

The power source of one or more of these clauses, wherein the second power output provides power to a second electrical load.

The power source of one or more of these clauses, wherein the second electrical load is outside the engine.

The power source of one or more of these clauses, wherein the second electrical load is an engine accessory selected from a group consisting of an engine pump, an engine starter, an engine control unit, and a combination thereof.

The power source of one or more of these clauses, wherein a voltage of the first power output is at least two times a voltage of the second power output.

The power source of one or more of these clauses, wherein a voltage of the first power output is at least 1.25 times a voltage of the second power output, such as at least 1.5 times a voltage of the second power output, such as at least 1.75 times a voltage of the second power output, such as up to 50 times a voltage of the second power output, such as up to 20 times a voltage of the second power output.

The power source of one or more of these clauses, wherein the engine is a gas turbine engine comprising a combustion section, wherein the first fuel cell group comprises a fuel cell, wherein the fuel cell defines an outlet positioned to provide output products from the fuel cell to the combustion section.

The power source of one or more of these clauses, wherein the first fuel cell group, the second fuel cell group, or both include a plurality of fuel cells, wherein the plurality of fuel cells are selected from a group consisting solid oxide fuel cells, polymer electrolyte membrane fuel cells, direct methanol fuel cells, alkaline fuel cells, phosphoric acid fuel cells, molten carbonate fuel cells, reversible fuel cells, and combinations thereof.

A power source for an aircraft having an engine, the power source comprising: a fuel cell assembly configured to be integrated into the engine, the fuel cell assembly comprising: a first fuel cell group; and a second fuel cell group, wherein during at least a first operating condition, the fuel cell assembly is configured to provide a first power output from the first fuel cell group and the second fuel cell group to a first electrical load.

The power source of one or more of these clauses, wherein the first power output provides power to the first electrical load through a first DC power bus.

The power source of one or more of these clauses, wherein during at least a second operating condition, the fuel cell assembly is configured to provide a second power output to a second electrical load.

The power source of one or more of these clauses, wherein the second power output provides power to the second electrical load through a second DC power bus.

The power source of one or more of these clauses, wherein the first fuel cell group is electrically coupled to the first electrical load through the first DC power bus.

The power source of one or more of these clauses, wherein during at least a second operating condition the second fuel cell group is electrically coupled to the second electrical load through the second DC power bus.

A power source for an aircraft having an engine, the power source comprising: a first power bus; a second power bus; and a fuel cell assembly configured to be integrated into the engine, the fuel cell assembly comprising: a first fuel cell group; and a second fuel cell group, wherein during at least a first operating condition of the power source the fuel cell assembly is configured to provide a first power bus output from the first fuel cell group, the second fuel cell group, or both to the first power bus and is further configured to provide a second power bus output to the second power bus, the second power bus output being different than the first power bus output.

The power source of one or more of these clauses, wherein the first fuel cell group is configured to provide a first power output and is electrically coupled to the first power bus for providing the first power output to the first power bus as the first power bus output, and wherein the second fuel cell group is configured to provide a second power output and is electrically coupled to the second power bus for providing the second power output to the second power bus as the second power bus output.

The power source of one or more of these clauses, wherein the first power output is at least 10% greater than the second power output.

The power source of one or more of these clauses, wherein the first fuel cell group is structured differently than the second fuel cell group.

The power source of one or more of these clauses, wherein the first fuel cell group is configured to provide a first power output and is electrically coupled to the first power bus for providing the first power output to the first power bus as part of the first power bus output, wherein the second fuel cell group is selectively in electrical communication with the second power bus and is configured to provide a second power output, and wherein when the second fuel cell group is electrically disconnected from the second power bus the second fuel cell group provides the second power output to the first power bus as part of the first power bus output.

The power source of one or more of these clauses, wherein during the first operating condition the second fuel cell group is electrically disconnected from the second power bus, wherein when the second fuel cell group is electrically disconnected from the second power bus, the second fuel cell group is electrically connected to the first power bus through the first fuel cell group in series.

The power source of one or more of these clauses, wherein during a second operating condition of the power source, the second fuel cell group is electrically connected to the second power bus and is electrically disconnected from the first power bus.

The power source of one or more of these clauses, wherein the second power bus output is 0 volts during the first operating condition of the power source.

The power source of one or more of these clauses, wherein the first power bus defines a maximum allowable voltage, and wherein a combination of the first power output from the first fuel cell group and the second power output from the second fuel cell group is less than the maximum allowable voltage.

The power source of one or more of these clauses, wherein the fuel cell assembly is a solid oxide fuel cell assembly.

The power source of one or more of these clauses, wherein the engine is a gas turbine engine comprising a combustion section, wherein the first fuel cell group comprises a fuel cell, wherein the fuel cell defines an outlet positioned to provide output products from the fuel cell to the combustion section.

The power source of one or more of these clauses, wherein the first power bus is an AC power bus, and wherein the second power bus is a DC power bus.

The power source of one or more of these clauses, wherein the second power bus distributes power to the engine, and wherein the first power bus distributes power to the aircraft external to the engine.

The power source of one or more of these clauses, wherein the second power bus is a DC power bus, wherein the DC power bus distributes power to the engine, and wherein the DC power bus provides power to one or more of a starter, a hydraulic or pneumatic pump, an electric motor, an engine control unit, or combination thereof.

The power source of one or more of these clauses, wherein the first power bus is an AC power bus, wherein the first fuel cell group is electrically coupled to the AC power bus with a DC/AC converter configured to convert DC power to AC power.

The power source of one or more of these clauses, further comprising an energy storage system electrically coupled to the second power bus to provide power to the second power bus and to be recharged by the fuel cell assembly.

The power source of one or more of these clauses, further comprising an alternative power source electrically coupled to the second power bus.

An aircraft comprising: a gas turbine engine; and a power source, the power source comprising: a first power bus; a second power bus; and a fuel cell assembly integrated into the gas turbine engine, the fuel cell assembly comprising: a first fuel cell group; and a second fuel cell group, wherein during at least a first operating condition of the power source, the fuel cell assembly is configured to provide a first power bus output from the first fuel cell group, the second fuel cell group, or both to the first power bus and is further configured to provide a second power bus output to the second power bus, the second power bus output being different than the first power bus output.

A method of operating a power source for an aircraft having an engine, the power source comprising a fuel cell assembly integrated into the engine, the method comprising: providing, during a first operating condition, a first power output to a first electrical load, the first power output being a combination of a first fuel cell group output of a first fuel cell group of the fuel cell assembly and a second fuel cell group output of a second fuel cell group of the fuel cell assembly; and providing, during a second operating condition: a first power output to the first electrical load, the first power output being the first fuel cell group output from the first fuel cell group; and a second power output to a second electrical load, the second power output being the second fuel cell group output from the second fuel cell group.

The method of one or more of these clauses, wherein providing, during the first operating condition, the first power output to the first electrical load comprises disconnecting the second fuel cell group from the second electrical load and connecting the second fuel cell group to the first fuel cell group in series.

The method of one or more of these clauses, wherein the first power output provides power to the first electrical load through a first DC power bus.

The method of one or more of these clauses, wherein the first electrical load is an engine accessory selected from a group consisting of an engine pump, an engine starter, an engine control unit, and a combination thereof.

A method of operating a power source for an aircraft having an engine, the power source comprising a first power bus, a second power bus, and a fuel cell assembly integrated into the engine, the method comprising: providing, during a first operating condition, a first power bus output to the first power bus, the first power bus output being a combination of a first power output of a first fuel cell group of the fuel cell assembly and a second power output of a second fuel cell group of the fuel cell assembly; and providing, during a second operating condition, the first power output from the first fuel cell group to the first power bus as the first power bus output and the second power output of the second fuel cell group to the second power bus as a second power bus output.

The method of one or more of these clauses, wherein providing, during the first operating condition, the first power bus output to the first power bus comprises disconnecting the second fuel cell group from the second power bus and connecting the second fuel cell group to the first fuel cell group in series.

We claim:

1. A power source for an aircraft having an engine, the power source comprising:
a fuel cell assembly configured to be integrated into the engine, the fuel cell assembly comprising:
a first fuel cell group; and
a second fuel cell group,
wherein during a first operating condition of the power source the fuel cell assembly is configured to provide a first power output from the first fuel cell group and the second fuel cell group and during a second operating condition is further configured to provide a second power output from the first fuel cell group, the second power output being different than the first power output.

2. The power source of claim 1, wherein the first power output provides power to a first electrical load.

3. The power source of claim 2, further comprising a first DC power bus, wherein the first power output provides power to a first electrical load through the first DC power bus.

4. The power source of claim 2, wherein the first electrical load is an engine accessory selected from a group consisting of an engine pump, an engine starter, an engine control unit, and a combination thereof.

5. The power source of claim 1, wherein the second power output provides power to a second electrical load.

6. The power source of claim 5, wherein the second electrical load is outside the engine.

7. The power source of claim 5, wherein the second electrical load is an engine accessory selected from a group consisting of an engine pump, an engine starter, an engine control unit, and a combination thereof.

8. The power source of claim 1, wherein a voltage of the first power output is at least two times a voltage of the second power output.

9. The power source of claim 1, wherein the engine is a gas turbine engine comprising a combustion section, wherein the first fuel cell group comprises a fuel cell, wherein the fuel cell defines an outlet positioned to provide output products from the fuel cell to the combustion section.

10. The power source of claim 1, wherein the first fuel cell group, the second fuel cell group, or both include a plurality of fuel cells, wherein the plurality of fuel cells are selected from a group consisting solid oxide fuel cells, polymer electrolyte membrane fuel cells, direct methanol fuel cells, alkaline fuel cells, phosphoric acid fuel cells, molten carbonate fuel cells, reversible fuel cells, and combinations thereof.

11. A power source for an aircraft having an engine, the power source comprising:
a fuel cell assembly configured to be integrated into the engine, the fuel cell assembly comprising:
a first fuel cell group; and
a second fuel cell group,
wherein during at least a first operating condition, the fuel cell assembly is configured to provide a first power output from the first fuel cell group and the second fuel cell group to a first electrical load.

12. The power source of claim 11, wherein the first power output provides power to the first electrical load through a first DC power bus.

13. The power source of claim 11, wherein during at least a second operating condition, the fuel cell assembly is configured to provide a second power output to a second electrical load.

14. The power source of claim 13, wherein the second power output provides power to the second electrical load through a second DC power bus.

15. The power source of claim 12, wherein the first fuel cell group is electrically coupled to the first electrical load through the first DC power bus.

16. The power source of claim 14, wherein during at least a second operating condition the second fuel cell group is electrically coupled to the second electrical load through the second DC power bus.

17. A method of operating a power source for an aircraft having an engine, the power source comprising a fuel cell assembly integrated into the engine, the method comprising:
providing, during a first operating condition, a first power output to a first electrical load, the first power output being a combination of a first fuel cell group output of a first fuel cell group of the fuel cell assembly and a second fuel cell group output of a second fuel cell group of the fuel cell assembly; and
providing, during a second operating condition:
a first power output to the first electrical load, the first power output being the first fuel cell group output from the first fuel cell group; and
a second power output to a second electrical load, the second power output being the second fuel cell group output from the second fuel cell group.

18. The method of claim 17, wherein providing, during the first operating condition, the first power output to the first electrical load comprises disconnecting the second fuel cell group from the second electrical load and connecting the second fuel cell group to the first fuel cell group in series.

19. The method of claim 17, wherein the first power output provides power to the first electrical load through a first DC power bus.

20. The method of claim 17, wherein the first electrical load is an engine accessory selected from a group consisting of an engine pump, an engine starter, an engine control unit, and a combination thereof.
